(19) United States
(12) Patent Application Publication
(10) Pub. No.: US 2002/0101789 A1
(43) Pub. Date: Aug. 1, 2002

(54) Clock having a weight with a liquid content

(76) Inventor: Shu-Hua Tseng, Miao Li Hsien (TW)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 09/770,492

(22) Filed: Jan. 29, 2001

(51) Int. Cl. G04B 37/00

(52) U.S. Cl. 368/285

(57) ABSTRACT

A clock having a transparent weight with a liquid content comprising a clock shell installed with a set of clockwork, with a pendulum positioned inside the clock shell. The transparent weight at the bottom of the pendulum consists of a transparent container filled with liquid and an adornment floating on the surface of the liquid. A piece of magnet is fastened onto the pendulum, and a piece of electromagnet is attached to the bottom of the clock. The nature of the magnetic attraction of the iron alternates with the change of the electric current being passed through the iron, which causes the pendulum to swing back and forth. As the pendulum swings, the liquid in the transparent container fluctuates, shaking the adornment to achieve an animated effect.

### BACKGROUND OF THE INVENTION

I. Field of the Invention

The present invention relates generally to a clock having a transparent weight with a liquid content and, more specifically, to a clock having a weight hung at the bottom of the pendulum, with the transparent weight filled with liquid and an adornment, shaken by fluctuating liquid as the pendulum swings, giving an animated effect to the clock.

II. Description of the Prior Art

Heretofore, it is known to construct a clock with the main purpose for measuring and showing time. A clock of such construction typically has its parts installed in a cubic shape of shell, which does not appeal to consumers.

It is also known to construct a clock having an appealing outward appearance, designed with a variety of adornments, such as cartoon characters and artistic drawings, and expected to boost purchase intent among consumers. Nonetheless, a clock adornment of this kind tends to be motionless and cannot effectively enhance consumers' purchase intent.

The present invention improves on the heretofore known clock by providing a transparent weight with a liquid content. A set of clockwork is installed in a clock shell, with the pendulum positioned inside the lower part of the clock shell. The transparent weight is filled with liquid and an adornment that floats on the surface of the liquid. A piece of magnet is fixed onto the pendulum, and a piece of electromagnet is attached on the bottom of the clock. As the electric current is alternated, the nature of the magnetic force changes, which manipulates the magnetic attraction between the magnet and the iron and thus causes the pendulum to swing. The swinging of the pendulum leads to the fluctuation of the liquid inside the transparent container, which in turn shakes the adornment and thus gives an animated effect to the clock.

### SUMMARY OF THE INVENTION

It is therefore a primary object of the invention to provide a clock with a specially-designed transparent weight filled with at least one kind of liquid and an adornment so that the adornment floating on the surface of the liquid fluctuates as the pendulum swings, giving an animated effect.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a top plan view of the present invention;

FIG. 2 is a sectional view of a clock constructed in accordance with the present invention.

### DESCRIPTION OF THE PREFERRED EMBODIMENT

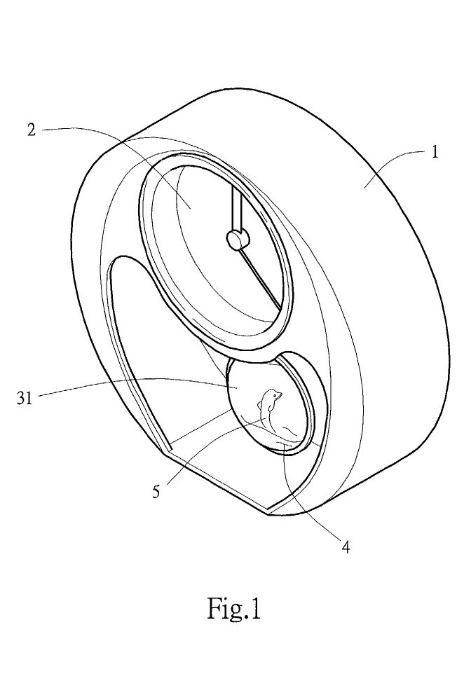

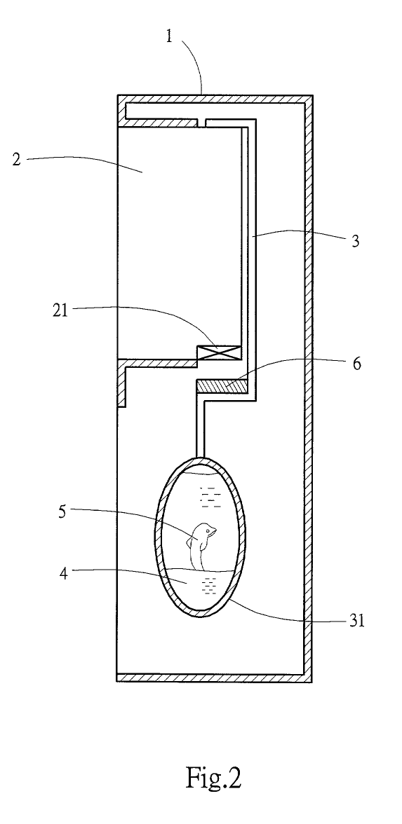

As can be seen in FIG. 1 and FIG. 2, the present invention is composed of a clock shell 1 incorporating a clock 2, with a pendulum 3 positioned inside the clock shell 1 and able to swing freely.

The weight 31 hung at the bottom of the pendulum 3 consists of a transparent container, in which filled with liquid 4 and an adornment 5 floating on the surface of the liquid 4. A piece of magnet 6 is fixed onto the pendulum 3, and a piece of electromagnet 21 is attached to the bottom of the clock 2.

As the electric current passed around the iron 21 is alternated, the magnetic force generated by the magnetized iron 21 changes, which either draws the magnet 6 on the pendulum 3 towards or away from the iron 21, making the pendulum 3 to swing back and forth. Inside the transparent weight 31 filled with liquid 4 and an adornment 5. Whenever the pendulum 3 swings, the liquid 4 fluctuates and thus shakes the adornment 5 to give the effect of animation for the clock.

As an application of the present invention, the transparent weight 31 at the bottom of the pendulum 3 can be filled with two types of liquid with different densities and an adornment 5 with the degree of density between that of these two types of liquid so that the adornment 5 fluctuates between these two types of liquid when the pendulum 3 swings.

While a preferred embodiment of the invention has been shown and described in detail, it will be readily understood and appreciated that numerous omissions, changes and additions may be made without departing from the spirit and scope of the invention.

What the invention claimed is:

1. A clock having a transparent weight with a liquid content comprising:
a clock shell,
a clock incorporated in said clock shell,
a pendulum positioned inside said clock shell, able to swing freely,
a transparent weight hung at the bottom of said pendulum;
wherein at least one kind of liquid and an adornment is filled in said transparent weight; and a piece of magnet attached to said pendulum, a piece of electromagnet fastened onto the bottom of said clock;
wherein the alternated magnetism of the magnetic force of said electromagnet draws said magnet towards or away from thereof, causing said pendulum to swing.

2. A clock having a transparent weight with a liquid content according to claim 1, wherein said transparent weight comprises two types of liquid with different densities and an adornment with the degree of density between that of these two types of said liquid so that said adornment can float between these two types of said liquid as said pendulum swings.
